(19) United States
(12) Patent Application Publication
(10) Pub. No.: US 2023/0294468 A1
(43) Pub. Date: Sep. 21, 2023

(54) ARTICULATING TRAILER HITCH ASSEMBLY

(71) Applicant: Tri Enterprises Ltd., Saskatoon (CA)

(72) Inventors: Walter Mah, Saskatoon (CA); Darren Borstmayer, Saskatoon (CA)

(73) Assignee: Tri Enterprises Ltd., Saskatoon, SK (CA)

(21) Appl. No.: 18/245,368

(22) PCT Filed: Sep. 15, 2021
(86) PCT No.: PCT/CA2021/000086

§ 371 Date: Mar. 15, 2023

(30) Foreign Application Priority Data
Sep. 15, 2020 (CA) 3093116

(51) Int. Cl. B60D 1/44; B60D 1/40; B60D 1/52

(52) U.S. Cl. CPC B60D 1/44; B60D 1/40; B60D 1/52

(57) ABSTRACT

An articulated trailer hitch assembly for coupling a trailing unit to a towing vehicle is provided. The articulated trailer hitch assembly comprises a towing vehicle engagement member adapted for being mounted to the towing vehicle at a first end portion thereof An articulating member is pivotally movable mounted to the towing vehicle engagement member at a second end portion thereof. A trailing unit engagement member is longitudinally movable mounted to the articulating member. The trailing unit engagement member is longitudinally movable between a retracted position and an extended position. The trailing unit engagement member is adapted for being coupled to the trailing unit.

### FIELD OF THE INVENTION

The present invention relates to hitches for towing trailers, and more particularly to an articulating trailer hitch assembly that is adapted for being mounted to a towing vehicle.

### BACKGROUND OF THE INVENTION

The use of towable trailers for hauling materials/equipment or equipment adapted for being towed such as, for example, farm implements, behind a towing vehicle such as, for example, a car, truck, tractor, or ATV, is well known. Typically, trailer hitches comprise a metal ball adapted for being mated with a respective ball mount disposed at a front end of a tongue—also known as a towbar or drawbar—of the trailer, or a pintle hook adapted for being mated with a respective lunette ring, which are connected to the towing vehicle and the trailer in a rigid manner.

Unfortunately, with the metal ball and the ball mount being connected in a rigid manner, precise alignment of the metal ball with the ball mount is required prior engagement of the same. Although the towing vehicle can be maneuvered into position while the trailer is stationery to enable engagement, the driver normally can not see the ball and the ball mount while controlling the towing vehicle and thus must generally proceed by trial and error until proper alignment is achieved. The problem is lessened to some extent when there is a person who can stand within view of the driver to direct him/her to a position where the metal ball is aligned with the ball mount.

It is desirable to provide an articulating trailer hitch assembly that enables pivotal and telescoping movement of the metal ball or pintle hook for facilitating alignment of the same with the respective ball mount or lunette ring while the towing vehicle and the trailer are stationary.

It is also desirable to provide an articulating trailer hitch assembly that enables pivotal and telescoping movement of the metal ball or pintle hook that is sufficiently compact for being mounted to a towing vehicle.

It is also desirable to provide an articulating trailer hitch assembly that enables pivotal and telescoping movement of the metal ball or pintle hook that is sufficiently compact for being mounted to a towing vehicle and that can be retrofitted to existing mounts on towing vehicles.

It is also desirable to provide an articulating trailer hitch assembly that enables pivotal and telescoping movement of the metal ball or pintle hook that is simple and easy to use.

### SUMMARY OF THE INVENTION

Accordingly, one object of the present invention is to provide an articulating trailer hitch assembly that enables pivotal and telescoping movement of the metal ball or pintle hook for facilitating alignment of the same with the respective ball mount or lunette ring while the towing vehicle and the trailer are stationary.

Another object of the present invention is to provide an articulating trailer hitch assembly that enables pivotal and telescoping movement of the metal ball or pintle hook that is sufficiently compact for being mounted to a towing vehicle.

Another object of the present invention is to provide an articulating trailer hitch assembly that enables pivotal and telescoping movement of the metal ball or pintle hook that is sufficiently compact for being mounted to a towing vehicle and that can be retrofitted to existing mounts on towing vehicles.

Another object of the present invention is to provide an articulating trailer hitch assembly that enables pivotal and telescoping movement of the metal ball or pintle hook that is simple and easy to use.

According to one aspect of the present invention, there is provided an articulated trailer hitch assembly for coupling a trailing unit to a towing vehicle. The articulated trailer hitch assembly comprises a towing vehicle engagement member adapted for being mounted to the towing vehicle at a first end portion thereof. An articulating member is pivotally movable mounted to the towing vehicle engagement member at a second end portion thereof. A trailing unit engagement member is longitudinally movable mounted to the articulating member. The trailing unit engagement member is longitudinally movable between a retracted position and an extended position. The trailing unit engagement member is adapted for being coupled to the trailing unit.

According to the aspect of the present invention, there is provided an articulated trailer hitch assembly for coupling a trailing unit to a towing vehicle. The articulated trailer hitch assembly comprises a towing vehicle engagement member adapted for being mounted to the towing vehicle at a first end portion thereof. An articulating member is pivotally movable mounted to the towing vehicle engagement member at a second end portion thereof. A trailing unit engagement member is longitudinally movable mounted to the articulating member. The trailing unit engagement member is longitudinally movable between a retracted position and an extended position. The trailing unit engagement member is adapted for being coupled to the trailing unit. An articulating member locking element is adapted for securing the articulating member to the towing vehicle engagement member such that a longitudinal axis of the articulating member is substantially aligned with a longitudinal axis of the towing vehicle engagement member. The articulating member locking element comprises a locking pin adapted for being accommodated in respective holes disposed in the towing vehicle engagement member and the articulating member. A trailing unit engagement member locking element is adapted for securing the trailing unit engagement member to the articulating member in the retracted position. The trailing unit engagement member locking element comprises a locking pin adapted for being accommodated in respective holes disposed in the articulating member and the trailing unit engagement member. A trailing unit engagement member stopping element secures the trailing unit engagement member in the extended position.

According to the aspect of the present invention, there is provided an articulated trailer hitch assembly for coupling a trailing unit to a towing vehicle. The articulated trailer hitch assembly comprises a towing vehicle engagement member adapted for being mounted to the towing vehicle at a first end portion thereof. An articulating member is pivotally movable mounted to the towing vehicle engagement member at a second end portion thereof. A trailing unit engagement member is longitudinally movable mounted to the articulating member. The trailing unit engagement member is longitudinally movable between a retracted position and an extended position. The trailing unit engagement member is adapted for being coupled to the trailing unit. The articulating member comprises a pivot extending upwardly therefrom, the pivot being pivotally movable accommodated in a respective bore disposed in the towing vehicle engagement member. The towing vehicle engagement member comprises an articulating member support element for supporting the articulating member. The articulating member support element comprises a substantially flat plate oriented substantially perpendicular to the pivot. The articulating member support element comprises a guiding groove or guiding ridge and wherein the articulating member comprises a respective guiding ridge or guiding groove for interacting therewith. The articulating member and the trailing unit engagement member have a tubular structure. The articulating member is adapted for accommodating the trailing unit engagement member therein. The tubular structure of the articulating member and the trailing unit engagement member has a square cross-section. The pivot extends from a top surface of the articulating member oriented substantially perpendicular thereto and the articulating member support element is oriented substantially parallel to the top surface of the articulating member.

According to another aspect of the present invention, there is provided an articulated trailer hitch assembly for coupling a trailing unit to a towing vehicle. The articulated trailer hitch assembly comprises a towing vehicle engagement member adapted for being mounted to the towing vehicle at a first end portion thereof. An articulating member is pivotally movable mounted to the towing vehicle engagement member at a second end portion thereof. A trailing unit engagement member is longitudinally movable mounted to the articulating member. The trailing unit engagement member is longitudinally movable between a retracted position and an extended position. The trailing unit engagement member is adapted for being coupled to the trailing unit. The towing vehicle engagement member is adapted for being mated with an existing hitch mount of the towing vehicle and for being secured thereto. The towing vehicle hitch mount comprises a tubular structure and the towing vehicle engagement member is adapted for being accommodated in an interior of the towing vehicle mount.

The advantage of the present invention is that it provides an articulating trailer hitch assembly that enables pivotal and telescoping movement of the metal ball or pintle hook for facilitating alignment of the same with the respective ball mount or lunette ring while the towing vehicle and the trailer are stationary.

A further advantage of the present invention is that it provides an articulating trailer hitch assembly that enables pivotal and telescoping movement of the metal ball or pintle hook that is sufficiently compact for being mounted to a towing vehicle.

A further advantage of the present invention is that it provides an articulating trailer hitch assembly that enables pivotal and telescoping movement of the metal ball or pintle hook that is sufficiently compact for being mounted to a towing vehicle and that can be retrofitted to existing mounts on towing vehicles.

A further advantage of the present invention is that it provides an articulating trailer hitch assembly that enables pivotal and telescoping movement of the metal ball or pintle hook that is simple and easy to use.

### BRIEF DESCRIPTION OF THE DRAWINGS

A preferred embodiment of the present invention is described below with reference to the accompanying drawings, in which:

FIGS. 1 and 2 are simplified block diagrams illustrating in top perspective views an articulating trailer hitch assembly according to a preferred embodiment of the invention;

FIG. 3 to 5 are simplified block diagrams illustrating in top perspective views removal of locking pins, extension, and articulation, respectively, of the articulating trailer hitch assembly according to the preferred embodiment of the invention;

FIG. 6 is a simplified block diagram illustrating in a top perspective view a towing vehicle engagement member with articulating member support element of the articulating trailer hitch assembly according to the preferred embodiment of the invention;

FIG. 7 is a simplified block diagram illustrating in a top perspective view an articulating member with pivot of the articulating trailer hitch assembly according to the preferred embodiment of the invention;

FIG. 8 is a simplified block diagram illustrating in a top perspective view a trailing unit engagement member of the articulating trailer hitch assembly according to the preferred embodiment of the invention;

FIG. 9 is a simplified block diagram illustrating in a top perspective view a winch mechanism of the articulating trailer hitch assembly according to the preferred embodiment of the invention;

FIG. 10 is a simplified block diagram illustrating in a top perspective view a winch drum of the winch mechanism of the articulating trailer hitch assembly according to the preferred embodiment of the invention; and,

FIG. 11 to 13 are simplified block diagrams illustrating in top perspective views an articulating trailer hitch assembly according to another preferred embodiment of the invention with the articulating trailer hitch assembly being in a retracted position, an extended position, and an articulated position, respectively.

### DESCRIPTION OF THE PREFERRED EMBODIMENT

Unless defined otherwise, all technical and scientific terms used herein have the same meaning as commonly understood by one of ordinary skill in the art to which the invention belongs. Although any methods and materials similar or equivalent to those described herein can be used in the practice or testing of the present invention, the preferred methods and materials are now described.

While the description of the preferred embodiments hereinbelow is with reference to an articulating trailer hitch assembly adapted for being mated with existing tubular hitch mount of a towing vehicle, it will become evident to those skilled in the art that the embodiments of the invention are not limited thereto, but are also adaptable for being mounted in various different ways to a towing vehicle such as, for example, to a frame member of the towing vehicle.

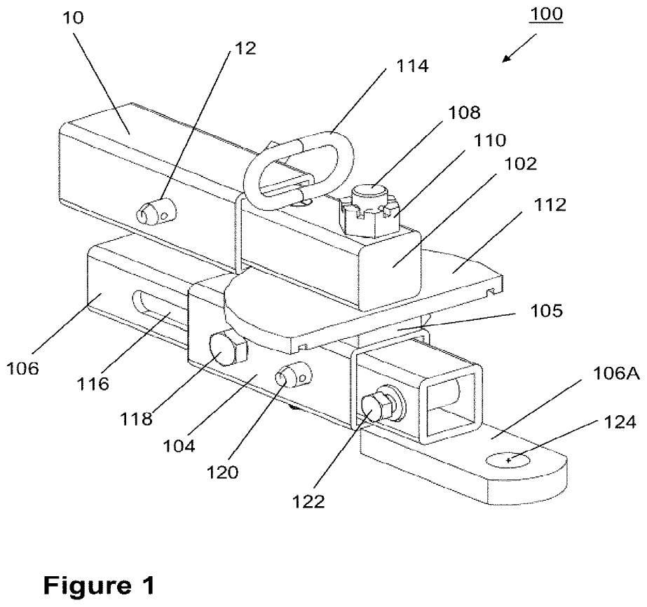

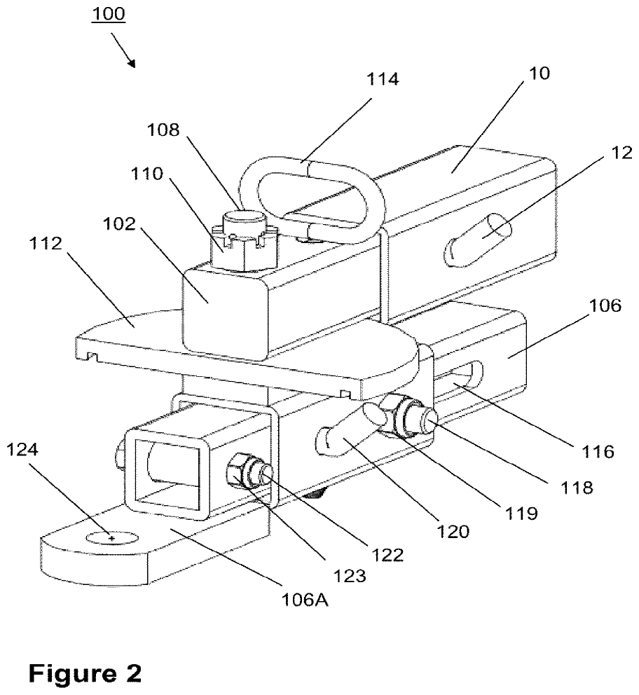

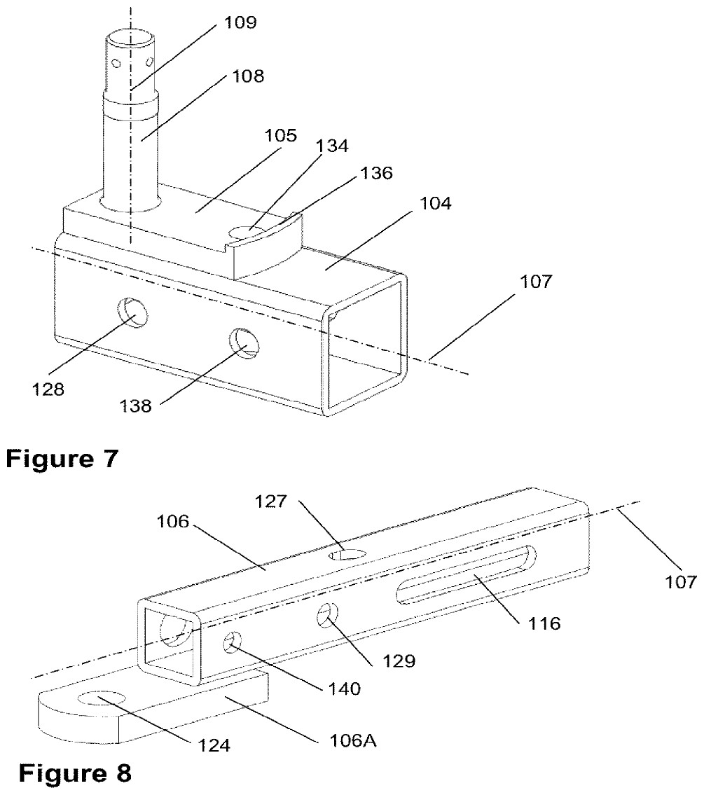

Referring to FIGS. 1 to 10 an articulating trailer hitch assembly 100 according to a preferred embodiment of the invention is provided. The articulating trailer hitch assembly 100 comprises towing vehicle engagement member 102 which is adapted for being mounted to the towing vehicle such as, for example, a car, truck, tractor, or ATV, at a first end portion thereof. Preferably, the towing vehicle engagement member 102 has a tubular or solid structure which is adapted for being mated with the interior of an existing tubular hitch mount 10 having, for example, a square cross-section, of the towing vehicle and for being secured thereto in a conventional manner, for example, via locking pin 12 accommodated in respective holes disposed in the hitch mount 10 and the towing vehicle engagement member 102, as illustrated in FIGS. 1 and 2. Articulating member 104 is pivotally movable mounted to the towing vehicle engagement member 102 at a second end portion thereof. Preferably, the articulating member 104 comprises a tubular structure having, for example, a square cross-section, and pivot 108 extending upwardly from a top surface thereof and oriented along axis 109 substantially perpendicular thereto, as illustrated in FIG. 7. The pivot 108 comprises, for example, a threaded top section and is adapted for being pivotally movable accommodated in respective bore 132 disposed in the towing vehicle engagement member 102 and secured thereto via nut 110, for example, a commercially available castle nut, as illustrated in FIGS. 1 to 6.

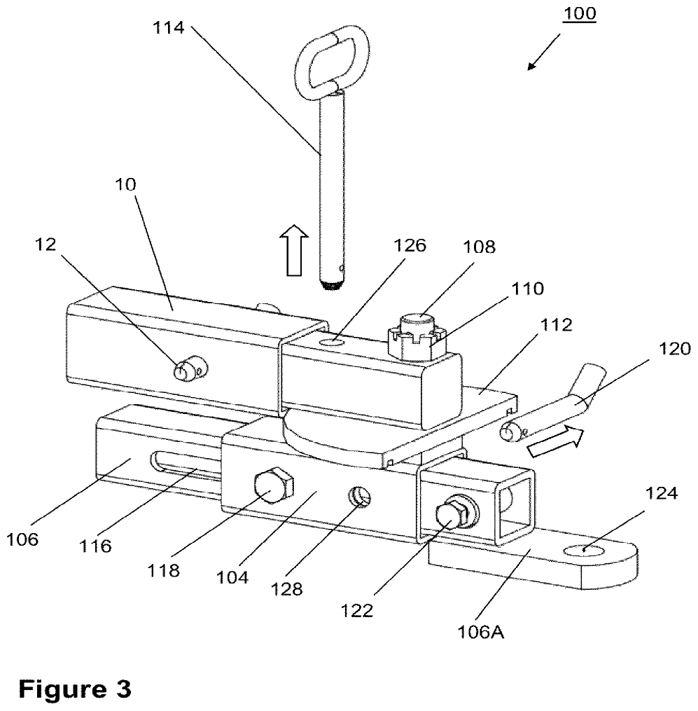

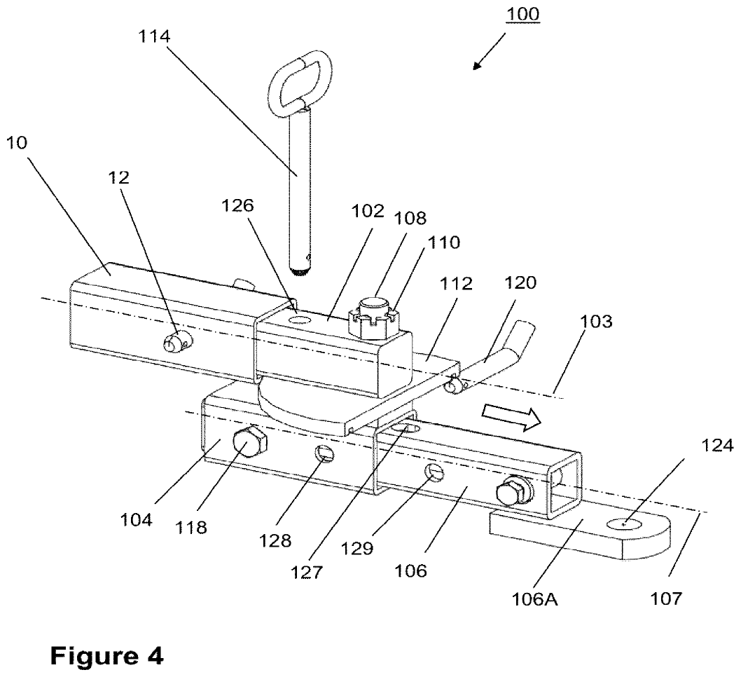

Trailing unit engagement member 106 is longitudinally movable mounted to the articulating member 104. Preferably, the trailing unit engagement member 106 has a tubular structure with, for example, a square cross-section, and is adapted for being longitudinally movable accommodated inside the tubular structure of the articulating member 104 such that the same is movable between a retracted position, as illustrated in FIG. 3, and an extended position, as illustrated in FIG. 4. The trailing unit engagement member 106 has trailing unit mounting element 106A attached thereto which comprises, for example, bore 124 for mounting a trailing unit coupling element such as, for example, a metal ball or pintle hook thereto.

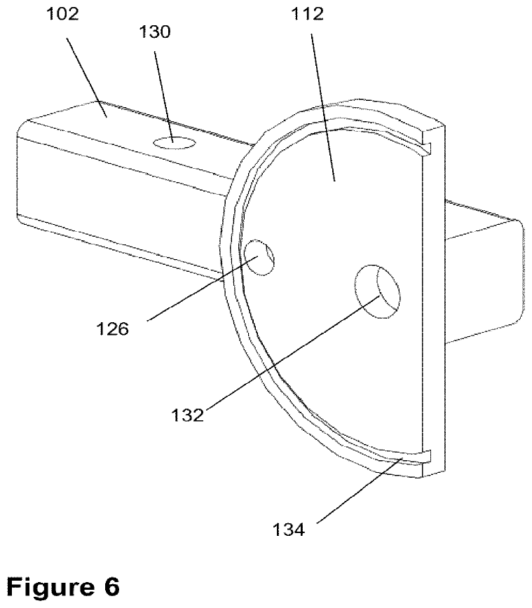

Articulating member locking element 114 secures the articulating member 104 to the towing vehicle engagement member 102 such that a longitudinal axis 107 of the articulating member 104 is substantially aligned with a longitudinal axis 103 of the towing vehicle engagement member 102, for example, during use of the articulating trailer hitch assembly 100 for towing a trailing unit or when the towing vehicle is used without a trailing unit, as illustrated in FIGS. 1 to 4. The articulating member locking element 114 comprises, for example, a locking pin 114 with a handle section for facilitating handling thereof that is adapted for being accommodated in bores 126, 127, and 134 disposed in the towing vehicle engagement member 102, the trailing unit engagement member 106, and the articulating member 104, respectively, as illustrated in FIGS. 6 to 8.

Trailing unit engagement member locking element 120 secures the trailing unit engagement member 106 to the articulating member 104 in the retracted position, for example, during use of the articulating trailer hitch assembly 100 for towing a trailing unit or when the towing vehicle is used without a trailing unit, as illustrated in FIGS. 1 to 3. The trailing unit engagement member locking element 120 comprises, for example, a locking pin 120 that is adapted for being accommodated in bores 128 and 129 disposed in the articulating member 104 and the trailing unit engagement member 106, respectively, as illustrated in FIGS. 1 to 4.

Trailing unit engagement member stopping element 118 secures the trailing unit engagement member 106 to the articulating member 104 in the extended position. The trailing unit engagement member stopping element 118 comprises, for example, screw bolt 118 secured to the articulating member 104 via bore 138 and nut 119, for example, a commercially available nylon-insert lock nut, with the screw bolt 118 being longitudinally movable accommodated in slot 116 disposed in the trailing unit engagement member 106 for enabling longitudinal movement between the retracted position and the extended position, as illustrated in FIGS. 1 to 4, 7, and 8.

Preferably, the towing vehicle engagement member 102 comprises an articulating member support element 112, for example, semi-circular substantially flat plate oriented substantially perpendicular to the pivot 118 and substantially parallel to the top surface of the articulating member 104, mounted thereto for supporting the articulating member 104 while the same is rotated about the pivot 118. Further preferably, the articulating member support element 112 comprises a guiding groove 134 or, alternatively, guiding ridge which is adapted for engaging a respective guiding ridge 136 or, alternatively, guiding groove disposed on the top surface of the articulating member 104, as illustrated in FIGS. 6 and 7.

Further preferably, the articulating member 104 comprises re-enforcement element 105 disposed on the top surface thereof for transferring a load exerted by the trailing unit onto the trailing unit mounting element 106A to the towing vehicle engagement member 102 in concert with the pivot 118.

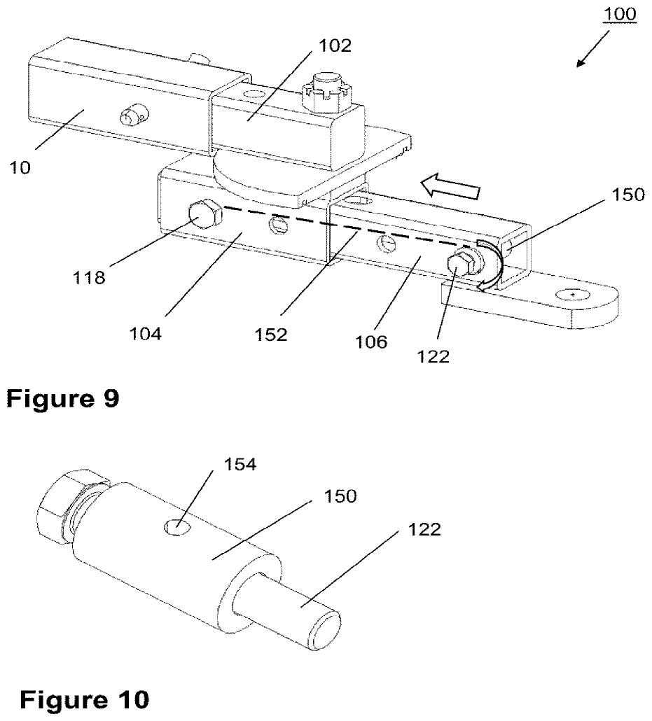

Further preferably, the articulating trailer hitch assembly 100 comprises a winch mechanism for manually retracting the trailing unit engagement member 106 into the articulating member 104 after the towing vehicle has been coupled to the trailing unit. As illustrated in FIGS. 9 and 10, the winch mechanism, preferably, comprises winch drum 150—for example, a bushing mounted to screw bolt 122 in a conventional manner such as welding—pivotally movable mounted to the trailing unit engagement member 106 via the screw bolt 122 accommodated in bores 140 and secured via nut 123, for example, a commercially available nylon-insert lock nut, and winch cable 152 disposed inside the trailing unit engagement member 106 and mounted to the screw bolt 118 and the winch drum 150 via bore 154. In operation, the trailing unit engagement member 106 is retracted by manually turning the screw bolt 122 using a wrench or crank, as indicated by the block arrows in FIG. 9.

The various components are made of, for example, steel such as commercially available steel tubing and steel sheet metal using conventional steel processing technologies such as drilling, welding, etc., as well as commercially available bolts and pins. In an example implementation, the towing vehicle engagement member 102 is made of a 2″×2″ steel bar having a length of approximately 9″, the articulating member 104 is made of 2½″×2½″ steel tubing having a length of approximately 6″, and the trailing unit engagement member 106 is made of 2″×2″ steel tubing having a length of approximately 12″. With the slot 116 having a length of approximately 3¾″ the articulating trailer hitch assembly 100 enables longitudinal movement of 3¾″ between the extended position and the retracted position while also having a compact size to enable mounting the same to a towing vehicle.

In use, the articulating trailer hitch assembly 100 is easily mounted to a towing vehicle by inserting the towing vehicle engagement member 102 into the tubular hitch mount 10 of the towing vehicle and securing the same by inserting locking pin 12 into respective holes disposed in the hitch mount 10 and the towing vehicle engagement member 102.

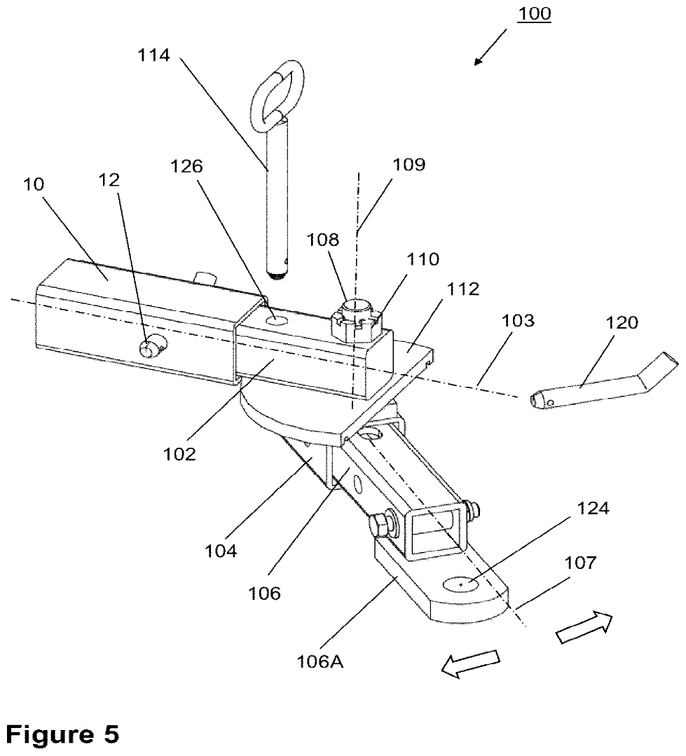

For coupling the towing vehicle to a trailing unit, the towing vehicle is placed such that the trailing unit mounting element 106A with the metal ball or pintle pin mounted thereto is in proximity to the ball mount or lunette ring of the trailing unit. After removal of the locking pins 114 and 120, as illustrated in FIGS. 2 and 3, the trailing unit mounting element 106A is moved longitudinally along the axis 107, as indicated by the block arrow in FIG. 4, and rotated about the axis 109, as indicated by the block arrow in FIG. 5, until the metal ball or pintle pin is placed accurately under the ball mount or lunette ring. After coupling of the metal ball or pintle pin with the ball mount or lunette ring the winch mechanism is activated by turning the screw bolt 122 until the trailing unit engagement member 106 is in the retracted position. The trailing unit engagement member 106 is then secured in the retracted position by inserting the locking pin 120 into the bores 128 and 129 disposed in the articulating member 104 and the trailing unit engagement member 106, respectively. Alternatively, the towing vehicle is slightly backed towards the trailing unit until the trailing unit engagement member 106 is in the retracted position. Further, the articulating trailer hitch assembly 100 is straightened, for example, by moving the towing vehicle with the trailing unit straight forward a short distance followed by inserting the locking pin 114 into the bores 126, 127, and 134 disposed in the towing vehicle engagement member 102, the trailing unit engagement member 106, and the articulating member 104, respectively, for securing the articulating member 104 to the towing vehicle engagement member 102 such that a longitudinal axis 107 of the articulating member 104 is substantially aligned with a longitudinal axis 103 of the towing vehicle engagement member 102. It is noted that the two actions of retracting and straightening may also be performed in reverse order.

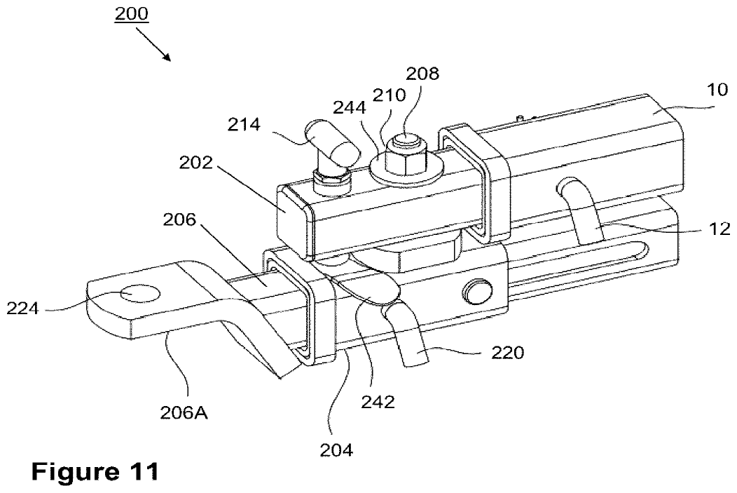

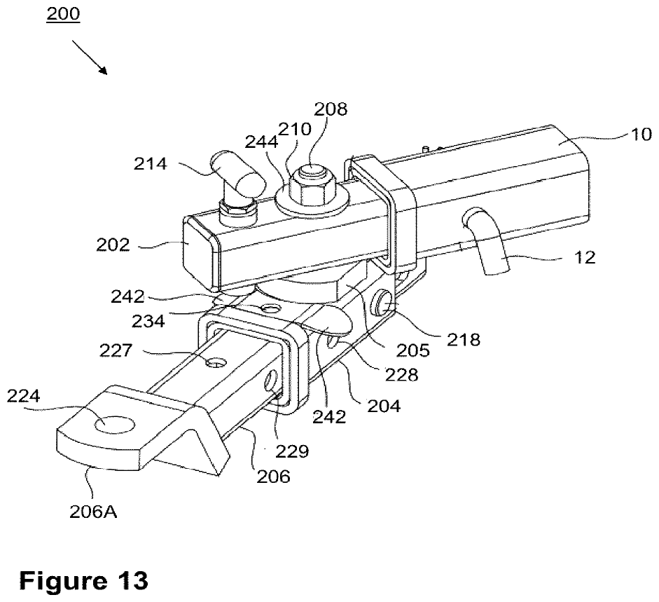

Referring to FIGS. 11 to 13 an articulating trailer hitch assembly 200 according to another preferred embodiment of the invention is provided. The articulating trailer hitch assembly 200 comprises towing vehicle engagement member 202 which is adapted for being mounted to the towing vehicle hitch mount 10 and for being secured thereto in a conventional manner, for example, via locking pin 12 accommodated in respective holes disposed in the hitch mount 10 and the towing vehicle engagement member 202. Articulating member 204 is pivotally movable mounted to the towing vehicle engagement member 202 at a second end portion thereof. Preferably, the articulating member 204 comprises a tubular structure having, for example, a square cross-section, and pivot 208 extending upwardly from a top surface thereof. The pivot 208 comprises, for example, a threaded top section and is adapted for being pivotally movable accommodated in a respective bore disposed in the towing vehicle engagement member 202 and secured thereto via nut 210 and washer 244.

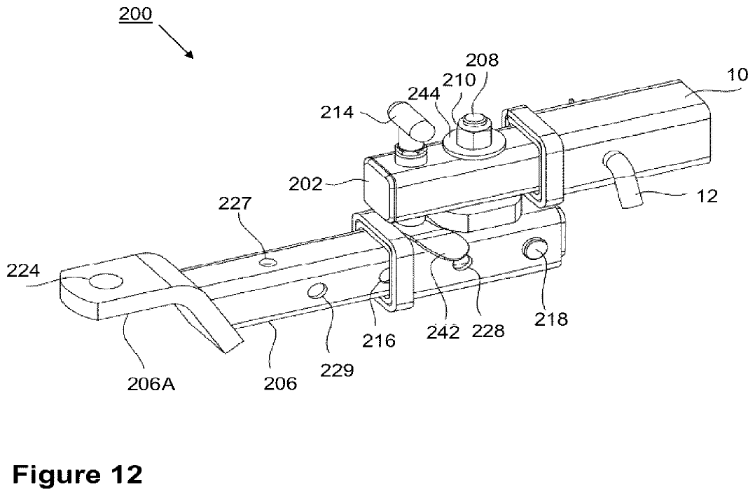

Trailing unit engagement member 206 is longitudinally movable mounted to the articulating member 204. Preferably, the trailing unit engagement member 206 has a tubular structure with, for example, a square cross-section, and is adapted for being longitudinally movable accommodated inside the tubular structure of the articulating member 204 such that the same is movable between a retracted position, as illustrated in FIG. 11, and an extended position, as illustrated in FIG. 12. The trailing unit engagement member 206 has trailing unit mounting element 206A attached thereto which comprises bore 224 for mounting a trailing unit coupling element such as, for example, a metal ball or pintle hook thereto.

Articulating member locking element 214 secures the articulating member 204 to the towing vehicle engagement member 202 such the articulating member 204 is substantially aligned with the towing vehicle engagement member 202. The articulating member locking element 214 comprises, for example, a locking pin 214 with a handle section for facilitating handling thereof that is adapted for being accommodated in bores disposed in the towing vehicle engagement member 202 and the articulating member 204. Flanges 242 provide for smooth sliding of the engagement end of the locking pin 214 when it is removed from engagement with bores 234 and 227.

Trailing unit engagement member locking element 220 secures the trailing unit engagement member 206 to the articulating member 204 in the retracted position, as illustrated in FIG. 11. The trailing unit engagement member locking element 220 comprises, for example, a locking pin 220 that is adapted for being accommodated in bores 228 and 229 disposed in the articulating member 204 and the trailing unit engagement member 206, respectively.

Trailing unit engagement member stopping element 218 secures the trailing unit engagement member 206 to the articulating member 204 in the extended position. The trailing unit engagement member stopping element 218 comprises, for example, screw bolt 218 secured to the articulating member 204 with the screw bolt 218 being longitudinally movable accommodated in slot 216 disposed in the trailing unit engagement member 206 for enabling longitudinal movement between the retracted position and the extended position, as illustrated in FIGS. 11 and 12.

The articulating trailer hitch assemblies 100, 200 are easily mounted to a towing vehicle having a towing mount unit, such as tubular mounts in common use on vehicles such as cars, trucks, tractors, and ATVs, providing a simple retrofit without the need for any additional modification. Furthermore, the articulating trailer hitch assemblies 100, 200 are easily moved from one towing vehicle to another. Yet further, the articulating trailer hitch assemblies 100, 200 enable use of one assembly 100, 200 for coupling a towing vehicle to one of a plurality of different trailing units, for example, for coupling a tractor to various different farming implements. The articulating trailer hitch assemblies 100, 200 are compact in size to enable mounting to a towing vehicle with trailing unit mounting element 106A being placed in close proximity to the hitch mount 10 when in the retracted position.

The present invention has been described herein with regard to preferred embodiments. However, it will be obvious to persons skilled in the art that a number of variations and modifications can be made without departing from the scope of the invention as described herein.

The embodiments of the invention in which an exclusive property or privilege is claimed are defined as follows:

1. An articulating trailer hitch assembly for coupling a trailing unit to a towing vehicle comprising:
a towing vehicle engagement member adapted for being mounted to the towing vehicle at a first end portion thereof;
an articulating member pivotally movable mounted to the towing vehicle engagement member at a second end portion thereof; and,
a trailing unit engagement member longitudinally movable mounted to the articulating member, the trailing unit engagement member being longitudinally movable between a retracted position and an extended position, the trailing unit engagement member being adapted for being coupled to the trailing unit.

2. The articulating trailer hitch assembly according to claim 1 comprising an articulating member locking element adapted for securing the articulating member to the towing vehicle engagement member such that a longitudinal axis of the articulating member is substantially aligned with a longitudinal axis of the towing vehicle engagement member.

3. The articulating trailer hitch assembly according to claim 2 wherein the articulating member locking element comprises a locking pin adapted for being accommodated in respective holes disposed in the towing vehicle engagement member and the articulating member.

4. The articulating trailer hitch assembly according to claim 2 comprising a trailing unit engagement member locking element adapted for securing the trailing unit engagement member to the articulating member in the retracted position.

5. The articulating trailer hitch assembly according to claim 4 wherein the trailing unit engagement member locking element comprises a locking pin adapted for being accommodated in respective holes disposed in the articulating member and the trailing unit engagement member.

6. The articulating trailer hitch assembly according to claim 4 comprising a trailing unit engagement member stopping element for securing the trailing unit engagement member in the extended position.

7. The articulating trailer hitch assembly according to claim 6 wherein the articulating member and the trailing unit engagement member have a tubular structure and wherein the articulating member is adapted for accommodating the trailing unit engagement member therein.

8. The articulating trailer hitch assembly according to claim 7 wherein the trailing unit engagement member comprises a slot for accommodating longitudinally movable the stopping element therein.

9. The articulating trailer hitch assembly according to claim 1 wherein the articulating member comprises a pivot extending upwardly therefrom, the pivot being pivotally movable accommodated in a respective bore disposed in the towing vehicle engagement member.

10. The articulating trailer hitch assembly according to claim 9 wherein the towing vehicle engagement member comprises an articulating member support element for supporting the articulating member.

11. The articulating trailer hitch assembly according to claim 10 wherein the articulating member support element comprises a substantially flat plate oriented substantially perpendicular to the pivot.

12. The articulating trailer hitch assembly according to claim 11 wherein the articulating member support element comprises a guiding groove or guiding ridge and wherein the articulating member comprises a respective guiding ridge or guiding groove for interacting therewith.

13. The articulating trailer hitch assembly according to claim 12 wherein the articulating member and the trailing unit engagement member have a tubular structure and wherein the articulating member is adapted for accommodating the trailing unit engagement member therein.

14. The articulating trailer hitch assembly according to claim 13 wherein the tubular structure of the articulating member and the trailing unit engagement member has a square cross-section, wherein the pivot extends from a top surface of the articulating member oriented substantially perpendicular thereto, and wherein the articulating member support element is oriented substantially parallel to the top surface of the articulating member.

15. The articulating trailer hitch assembly according to claim 1 wherein the towing vehicle engagement member is adapted for being mated with an existing hitch mount of the towing vehicle and for being secured thereto.

16. The articulating trailer hitch assembly according to claim 11 wherein the towing vehicle hitch mount comprises a tubular structure and wherein the towing vehicle engagement member is adapted for being accommodated in an interior of the towing vehicle mount.

17. The articulating trailer hitch assembly according to claim 1 comprising a winch mechanism for retracting the trailing unit engagement member.

18. The articulating trailer hitch assembly according to claim 1 wherein the trailing unit engagement member comprises a trailing unit mounting element for mounting a metal ball or pintle hook thereto.
